(19) United States
(12) Patent Application Publication
(10) Pub. No.: US 2021/0079153 A1
(43) Pub. Date: Mar. 18, 2021

(54) AROMATIC POLYISOCYANATES WITH A HIGH SOLIDS CONTENT

(71) Applicant: Covestro Deutschland AG, Leverkusen (DE)

(72) Inventors: Christoph Irle, Köln (DE); Dieter Mager, Leverkusen (DE); Hongchao Li, Pudong, Shanghai (CN); Hao Liu, Pudong, Shanghai (CN); Ling Yang, Pudong, Shanghai (CN); Na Xu, Pudong, Shanghai (CN); Guoping Shi, Shenzhen (CN)

(21) Appl. No.: 16/967,475

(22) PCT Filed: Feb. 11, 2019
(86) PCT No.: PCT/EP2019/053235

§ 371 Date: Aug. 5, 2020

(30) Foreign Application Priority Data
Feb. 13, 2018 (CN) PCT/CN2018/076632

(51) Int. Cl. C08G 18/76; C09D 175/08; C09D 175/06; C09J 175/08; C09J 175/06; C08G 18/80; C08G 18/78; C08G 18/66; C08G 18/48; C08G 18/42; C08G 18/32; C08G 18/22; C08G 18/12

(52) U.S. Cl. CPC C08G 18/7621; C08G 18/12; C09D 175/06; C09J 175/08; C09J 175/06; C08G 18/8029; C08G 18/8019; C08G 18/7837; C08G 18/6677; C08G 18/4854; C08G 18/4825; C08G 18/4288; C08G 18/3206; C08G 18/222; C09D 175/08

(57) ABSTRACT

The invention relates to an aromatic allophanate polyisocyanate based on aromatic diisocyanates, containing a) ≥15 mol-% of allophanate groups, based on the sum of urethane, allophanate and isocyanurate groups, b) ≤50 mol-% of isocyanurate groups, based on the sum of urethane, allophanate and isocyanurate groups and c) ≤1.5% by weight of monomeric diisocyanates, based on the total weight of the aromatic allophanate polyisocyanate. Furthermore, the invention relates to a process for producing aromatic allophanate polyisocyanates and their use in polyisocyanate compositions or two-component systems.

The present invention relates to an aromatic allophanate polyisocyanate. The invention additionally relates to a process for preparing the aromatic allophanate polyisocyanate and the use of a catalyst stopper. Furthermore, the present invention relates to a polyisocyanate composition and a two-component system containing the aromatic allophanate polyisocyanate. Additionally, the present invention relates to the use of the aromatic allophanate or the polyisocyanate composition as a crosslinker and a process for producing a composite system or a coated substrate as well as the composite system or coated substrate.

Polyisocyanates based on tolylene diisocyanate (in the following also abbreviated as TDI) are used commercially, among other purposes, in surface coatings and adhesives as crosslinkers in two-component polyurethane formulations. Their purpose is to effect chemical crosslinking of isocyanate-reactive components, e.g. polyols, and curing to give a chemicals-resistant and mechanically strong film. Physical mixtures of elastic and highly compatible urethanized TDI adducts (e. g. Desmodur® L75, Covestro AG) and fast curing isocyanurates of TDI (e. g. Desmodur® IL 1351, Covestro AG) are often used for this purpose.

Polyisocyanates based on urethane polymers have been used as crosslinkers in PU formulation. These polyisocyanates are obtained by converting polyols of different molecular weights with excess diisocyanates, as described e. g. in WO 2016/116376 A1 and EP 3 176 196 A1.

Polyisocyanates with isocyanurate structure are obtained by the trimerization of organic diisocyanates (cf. German Patents No. 951,168; 1,013,869 and 1,203,792; British Pat. No. 809,809 and 949,253; U.S. Pat. Nos. 3,154,522 and 2,801,244). Despite the fact that aromatic isocyanurate polyisocyanates afford the fast drying property as PU coating hardener, the unfavorable high viscosity, low compatibility and low flexibility limit the sole use of such isocyanurate polyisocyanates and require larger amounts of organic solvents. On the other hand, aromatic urethane polyisocyanates possess excellent compatibility and elasticity, however their drying speed is often too slow and normally has to be used by blending with the less compatible and high viscous aromatic isocyanurate type polyisocyanates.

There has long been a desire to prepare the known polyisocyanates of TDI firstly with a low viscosity and secondly with a high functionality, in order to reduce the content of volatile organic compounds (VOC) and provide a high curing efficiency of related formulations.

EP 0 751 163 A1 and EP 2 174 976 B1 suggested addition of monoalcohols to aromatic diisocyanates during or after conversion to the isocyanurate polyisocyanate. Such products still exhibit high viscosities and a very limited compatibility and elasticity.

There was always a desire to prepare an aromatic polyisocyanate with combined favorite performances of fast drying, high compatibility, good flexibility and low viscosity.

From the occupational hygiene point of view, low-monomer-content polyisocyanurates are preferred. In order to minimize the content of monomeric diisocyanates, it is common practice to convert monomeric diisocyanates into isocyanurate. However, this unfavorably leads to a relatively high molecular weight and thus high viscous isocyanurate polyisocyanates. Alternatively, the excess monomeric diisocyanates could be removed from the product by physical separation technologies, such as extraction with proper solvents and further removal of residual solvents in crude product. However, the consumption of organic solvents and complicated process increased the manufacture cost. Instead, evaporation is widely applied to reduce free monomer content of polyisocyanurates, for example by using e. g. thin film or short path evaporators.

Polyisocyanates containing allophanate groups and their use as binders are disclosed in GB994890 by reacting excess of isocyanates with hydroxyl group containing compounds at higher temperature (125-130° C.) for around 20 hours or at lower reaction temperature (45-55° C.) for days in the presence of catalysts. Although for aliphatic polyisocyanates the excess of monomeric aliphatic diisocyanate could be removed from product afterward by distillation, only extraction with petrol and no distillation was chosen to remove the excess of aromatic isocyanates (such as tolylene diisocyanate) from the crude aromatic allophanate polyisocyanates.

As disclosed in U.S. Pat. No. 5,672,736 and EP 0 807 623 allophanate polyisocyanates based on aromatic diisocyanates such as TDI were regarded to be unstable, especially when treated with thin film distillation equipment. Allophanate polyisocyanates disclosed in U.S. Pat. No. 3,769,318 by reacting N-substituted carbonic acid ester with organic isocyanates in the presence of alkylating catalyst were not further treated to remove excess of isocyanate monomers by distillation. Therefore, the high content of monomeric diisocyanate limits the use of such aromatic allophanate polyisocyanates, e. g. in coatings, adhesives or sealants applications.

It was an objective for this invention to provide low free monomer aromatic allophanate polyisocyanates, which have a good thinnability, compatibility and excellent elasticity, and at the same time a fast drying speed and which can be used to prepare high solids content polyisocyanate compositions.

It was another objective for present invention to provide a composition and a process for preparation of such aromatic allophanate polyisocyanates with above advantages and removal of unreacted organic isocyanate monomers, while providing sufficient stability to provide a technology that can be safely used e. g. in coatings, adhesives, sealants, elastomers and the like. Moreover, it was another object to provide an aromatic allophanate polyisocyanate which can be used in a two-component system in order to provide coatings having an excellent elasticity.

It was another object to combine excellent physico-chemical properties with ensuring a constant low value of monomeric residues even over time and/or elevated temperature, e.g. 50° C.

It was surprisingly found that above mentioned objects could be solved by providing an aromatic allophanate polyisocyanate based on aromatic diisocyanates, containing

a) ≥15 mol-% of allophanate groups, based on the sum of urethane, allophanate and isocyanurate groups,
b) ≤50 mol-% of isocyanurate groups, based on the sum of urethane, allophanate and isocyanurate groups and
c) ≤1.5% by weight of monomeric diisocyanates, based on the total weight of the aromatic allophanate polyisocyanate.

For the purposes of the invention, the references to “comprising”, “containing”, etc., preferably mean “consisting essentially of” and very particularly preferably “consisting of”.

The term “polyisocyanate” as used herein is a collective designation for a mixture of one or more oligomers which contain two or more isocyanate groups (by which the skilled person understands free isocyanate groups of the general structure —N═C═O). These oligomers comprise at least two monomeric diisocyanate molecules, meaning that they are compounds which contain or represent a reaction product of at least two monomeric diisocyanate molecules. The monomeric diisocyanate molecules (referred to below simply as monomeric diisocyanate or else starting diisocyanate) have a general structure O═C═N—R′—N═C═O, in which R′ typically stands for aliphatic, cycloaliphatic, aromatic and/or araliphatic radicals with the proviso that at least one R′ stands at least for an aromatic radical, more preferably R′ stands for a tolylene 2,4- or 2,6-radical-.

According to the present invention, the term tolylene diisocyanate (TDI) is used as collective term for the isomers tolylene 2,4-diisocyanate, tolylene 2,6-diisocyanate and any mixtures of tolylene 2,4- and 2,6-diisocyanate.

According to the present invention, the expression “based on aromatic diisocyanates” means that aromatic diisocyanates make up ≥50% by weight, preferably ≥70% by weight, particularly preferably ≥90% by weight and very particularly preferably ≥99% or 100% by weight, of the total compounds bearing isocyanate groups which are used.

According to the present invention, the amount of monomeric diisocyanates is determined by gas chromatography with an internal standard, in accordance with DIN EN ISO 10283:2007-11. To determine the long term stability of the polyisocyanate, the determination of the amount of monomeric diisocyanates is repeated after storage at elevated temperature, e. g. after storing a polyisocyanate sample at ambient or elevated temperature for several weeks. The term “monomeric diisocyanates” comprises also “aromatic diisocyanates” and their amounts which e.g. have not reacted during the synthesis of the inventive aromatic allophanate polyisocyanate.

According to the present invention, the molar contents of allophanate, urethane and isocyanurate groups are determined by ¹³C-NMR spectroscopy using CDCl₃ as solvent in accordance with DIN EN ISO 10283:2007-11.

According to the present invention, the NCO content is given in % by weight and is determined titrimetrically in accordance with DIN EN ISO 11909:2007-05.

According to the present invention, the average number molecular weight is determined by gel permeation chromatography (GPC) in accordance with DIN 55672-1:2016-03 using polystyrene as standard and tetrahydrofuran as eluent.

According to the present invention, the non-volatile content (NVC) is given in % by weight by testing method in accordance with DIN EN ISO 3251:2008-06 using a drying temperature and time of 2 hours at 120° C. and a test dish diameter of 75 mm and a weighed-in quantity of 2.00 g +/−0.02.

The characteristic allophanate group is shown in the following structural formula (I), wherein R is an aromatic radical as outlined above:

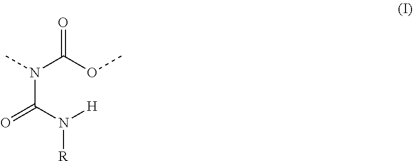

The average isocyanate group functionality of the aromatic allophanate polyisocyanate is determined in accordance with the following formula:

F(GPC)=Mn(GPC)×% NCO(titration)/42/% NVC

wherein the NCO content is given in % by weight and is determined titrimetrically in accordance with DIN EN ISO 11909:2007-05; the average number molecular weight is determined by gel permeation chromatography (GPC) in accordance with DIN 55672-1:2016-03 using polystyrene as standard and tetrahydrofuran as eluent; and the non-volatile content (NVC) is given in % by weight by testing method in accordance with DIN EN ISO 3251:2008-06 using a drying temperature and time of 2 hours at 120° C. and a test dish diameter of 75 mm and a weighed-in quantity of 2.00 g +/−0.02.

In a first preferred embodiment, the inventive aromatic allophanate polyisocyanate contains ≥20 mol-%, preferably ≥30 mol-% and more preferably ≥40 mol-% of allophanate groups, based on the sum of urethane, allophanate and isocyanurate groups. This is linked with the beneficial effect that the higher content of allophanate groups benefits higher average functionality and faster drying performance of the polyisocyanate product.

In a further preferred embodiment, the inventive aromatic allophanate polyisocyanate contains ≤40 mol-%, preferably ≤30 mol-%, more preferably ≤25 mol-% and most preferably ≤15 mol-% of isocyanurate groups, based on the sum of urethane, allophanate and isocyanurate groups. This is linked with the beneficial effect that less content of isocyanurate groups results better compatibility of the polyisocyanate product.

It is part of the nature of the synthesis route towards allophanate groups that an allophanate group containing polyisocyanate can—besides the above mentioned urethane and isocyanurate groups—contain minor amounts of further functional groups, such as urea, dimer, biuret, carbodiimide, uretonimine, uretdione or iminooxadiazinedione groups. In this regard, the term “minor amounts” means that of one or more of the aforementioned functional groups are preferably ≤5 mol-%, more preferably ≤2 mol-% and most preferably ≤0.5 mol-%, based on the sum of urethane, allophanate, isocyanurate and the aforementioned functional groups, can be contained in the inventive aromatic allophanate polyisocyanate.

In a further preferred embodiment, the inventive aromatic allophanate polyisocyanate contains ≤1.0% by weight, preferably ≤0.8% by weight and more preferably ≤0.7% by weight of monomeric diisocyanates, based on the total weight of the aromatic allophanate polyisocyanate. The term “monomeric diisocyanates” comprises also “aromatic diisocyanates” and their amounts which e.g. have not reacted during the synthesis of the inventive aromatic allophanate polyisocyanate.

In another preferred embodiment of the inventive aromatic allophanate polyisocyanate, the aromatic diisocyanate of which the polyisocyanate is based on is tolylene 2,4-diisocyanate, tolylene 2,6-diisocyanate or a mixture of tolylene 2,4- and 2,6-diisocyanate. In addition, the polyisocyanate may contain ≤50% by weight, preferably ≤20% by weight, more preferably ≤10% by weight, of other aliphatic, cycloaliphatic, araliphatic and/or aromatic diisocyanates other than TDI. Suitable monomeric diisocyanates, also referred to below as starting diisocyanates, are—for example—those of the molecular weight range 140 to 400 g/mol, such as, for example, 1,4-diisocyanatobutane, 1,5-diisocyanatopentane (PDI), 1,6-diisocyanatohexane (HDI), 1,5-diisocyanato-2,2-dimethylpentane, 2,2,4- and 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H-MDI), bis(isocyanatomethyl)norbornane (NBDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (XDI), 1,3- and 1,4-bis(1-isocyanato-1-methylethyl)benzene (TMXDI), bis(4-(1-isocyanato-1-methylethyl)phenyl) carbonate, 1,3- and 1,4-phenylene diisocyanate, diphenylmethane 2,4′- and/or 4,4′-diisocyanate and naphthylene 1,5-diisocyanate and also any desired mixtures of such diisocyanates. Further diisocyanates likewise suitable are additionally found, for example, in Justus Liebigs Annalen der Chemie, 1949, 562, 75-136. Preferred diisocyanates that can be combined with TDI include HDI (to improve the anti-yellowing, further reduce the viscosity and VOC) and IPDI (to improve yellowing and weathering stability) and MDI (to achieve an even faster drying speed) or mixtures thereof. If other diisocyanates are concomitantly used, the total amount of any monomeric diisocyanates still present is ≤1.5% by weight, preferably ≤1.0% by weight, more preferably ≤0.8% by weight and most preferably ≤0.7% by weight, based on the total weight of the aromatic allophanate polyisocyanate.

It is however most preferred to use tolylene 2,4- or 2,6-diisocyanate and also any desired mixtures of these isomers only, even more preferred is a mixture of tolylene 2,4- and 2,6-diisocyanate in a weight ratio of from 3:2 to 10:0 and preferably from 7:3 to 9:1. This is linked with the beneficial effect, that an optimal balance between excellent physico-chemical properties and economic production of the inventive allophanate polyisocyanates can be achieved.

In another preferred embodiment, the inventive aromatic allophanate polyisocyanate has an average isocyanate functionality of ≥2.5 to ≤8.0, preferably of ≥3.0 to ≤7.0 and most preferably of ≥4.0 to ≤6.5. The advantage of this is that the solvent resistance is further improved and the drying is accelerated, hence further improving the productivity of the coating operation. The average isocyanate functionality is calculated by the aforementioned formula.

Another especially preferred embodiment of the present invention is an aromatic allophanate polyisocyanate based on tolylene 2,4-diisocyanate, tolylene 2,6-diisocyanate or a mixture thereof, containing
a) ≥30 mol-% of allophanate groups, based on the sum of urethane, allophanate and isocyanurate groups,
b) ≤25 mol-% of isocyanurate groups, based on the sum of urethane, allophanate and isocyanurate groups,
c) ≤0.8% by weight of monomeric tolylene 2,4-diisocyanate and tolylene 2,6-diisocyanate, based on the total weight of the aromatic allophanate polyisocyanate and having
   an isocyanate functionality of ≥3.0 to ≤7.0.

Allophanate containing polyisocyanates are typically obtained by converting monomeric diisocyanates with OH-functional compounds in a two-step process. In a first step, monomeric diisocyanates are converted with OH-functional compounds to form a urethane groups containing product.

In a second step, a catalyst is added to the urethane groups containing product to facilitate conversion of urethane groups with excess diisocyanate to allophanate groups. In case the urethane groups containing product contains free isocyanate groups, these isocyanate groups can also be converted with urethane groups to allophanate groups.

Thus another subject of the present invention is a process for preparing an inventive aromatic allophanate polyisocyanate, comprising the steps
(i) reacting at least one aromatic diisocyanate with at least one hydroxyl group containing compound to form an urethane groups containing polyisocyanate,
(ii) reacting the urethane group containing polyisocyanate with an excess of at least one aromatic diisocyanate in the presence of at least one catalyst to form allophanate groups,
(iii) stopping the reaction by deactivation of the catalyst, preferably by addition of at least one catalyst stopper and more preferably by addition of at least one acidic catalyst stopper, and
(iv) removing the unreacted monomeric diisocyanate, preferably by evaporation.

The formation of allophanate groups in step (ii) is to be understood as the conversion of urethane groups with isocyanate groups of the at least one monomeric diisocyanate as well as the conversion of urethane groups with isocyanate groups of the urethane group containing polyisocyanate.

In a first preferred embodiment of the inventive process has the hydroxyl group containing compound an average molecular weight of ≥62 to ≤5000, preferably an average molecular weight of ≥62 to ≤2500, more preferably an average molecular weight of ≥62 to ≤1000.

Suitable hydroxyl group containing compounds for preparing the inventive aromatic allophanate polyisocyanate are, for example, any desired mono- or polyhydric alcohols having up to 6 OH groups, preferably 2 to 4 OH groups, such as, for example, the mono- or polyhydric alcohols stated below as suitable hydroxyl group containing catalyst solvents, and also tetrahydrofurfuryl alcohol, the isomeric pentanediols, hexanediols, heptanediols and octanediols, 1,10-decanediol, 1,2- and 1,4-cyclohexanediol, 1,4-cyclohexanedimethanol, 4,4′-(1-methylethylidene)biscyclohexanol, 1,1,1-trimethylolethane, 1,2,6-hexanetriol, 1,1,1-trimethylolpropane, 2,2-bis(hydroxymethyl)-1,3-propanediol, bis(2-hydroxyethyl) hydro-quinone, 1,2,4- and 1,3,5-trihydroxycyclohexane or 1,3,5-tris(2-hydroxyethyl) isocyanurate, but also simple ester alcohols, such as hydroxypivalic acid neopentyl glycol ester, for example.

Suitable hydroxyl group containing compounds for preparing the inventive aromatic allophanate polyisocyanate are also the polyhydroxyl compounds of relatively high molecular weight that are known per se, being of the polyester, polycarbonate, polyestercarbonate or polyether type, more particularly those of the molecular weight range 200 to 5000 g/mol, preferably 200 to 2500 g/mol. These polyhydroxyl compounds preferably have an average OH functionality of ≥1.5 and ≤5.0 and preferably an average OH functionality of ≥1.8 and ≤4.0.

Polyester polyols suitable as hydroxyl group containing compounds are, for example, those having an average molecular weight, as may be calculated from functionality and hydroxyl number, of 200 to 5000 g/mol, preferably of 200 to 2500 g/mol, and/or having a hydroxyl group value (OH value) of 16 to 1400 mg/g KOH, preferably 40 to 1120 mg/g KOH as may be prepared in a conventional way by reaction of polyhydric alcohols, examples being those stated above with 2 to 14 carbon atoms, with sub-stoichiometric amounts of polybasic carboxylic acids, corresponding carboxylic anhydrides, corresponding polycarboxylic esters of lower alcohols or lactones.

The acids or acid derivatives that are used for preparing the polyester polyols may be aliphatic, cycloaliphatic and/or aromatic in nature and may optionally be substituted—by halogen atoms, for example—and/or unsaturated. Examples of suitable acids are polybasic carboxylic acids of the molecular weight range 118 to 300 g/mol or derivatives thereof such as, for example, succinic acid, adipic acid, sebacic acid, phthalic acid, isophthalic acid, trimellitic acid, phthalic anhydride, tetrahydrophthalic acid, maleic acid, maleic anhydride, dimeric and trimeric fatty acids, dimethyl terephthalate and bisglycol terephthalate.

For preparing the polyester polyols it is also possible to use any desired mixtures of these exemplified starting compounds.

One kind of polyester polyols which can be used with preference as hydroxyl group containing compound are those which can be prepared in a conventional way from lactones and simple polyhydric alcohols, such as those exemplified above, for example, as starter molecules, with ring opening. Suitable lactones for preparing these polyester polyols are, for example, β-propiolactone, γ-butyrolactone, γ- and δ-valerolactone, ε-caprolactone, 3,5,5- and 3,3,5-trimethylcaprolactone, or any desired mixtures of such lactones.

Polyhydroxyl compounds of the polycarbonate type that are suitable as hydroxyl group containing compounds are, in particular, the polycarbonate diols which can be prepared, for example, by reaction of dihydric alcohols—for example, those as exemplified above in the list of polyhydric alcohols of the molecular weight range 62 to 400 g/mol—with diaryl carbonates, such as diphenyl carbonate, for example, dialkyl carbonates, such as dimethyl carbonate, for example, or phosgene.

Polyhydroxyl compounds of the polyester carbonate type that are suitable as hydroxyl group containing compounds are, in particular, the conventional diols containing ester groups and carbonate groups which can be prepared in accordance with the teaching of DE-A 1 770 245 or WO 03/002630, by reaction of dihydric alcohols with lactones of the type exemplified above, more particularly ε-caprolactone, and subsequent reaction of the resultant polyester diols with diphenyl carbonate or dimethyl carbonate.

Polyether polyols suitable as hydroxyl group containing compounds are, in particular, those with an average molecular weight, as may be calculated from functionality and hydroxyl number, of 200 to 5000 g/mol, preferably 200 to 2500 g/mol, more preferably 250 to 2500 g/mol, and/or having a hydroxyl group content value (OH value) of 16 to 1400 mg/g KOH, preferably 40 to 1120 mg/g KOH, more preferably 40 to 900 mg/g KOH, which can be prepared in a conventional way through alkoxylation of suitable starter molecules. For preparing these polyether polyols it is possible as starter molecules to use any desired polyhydric alcohols, such as the simple polyhydric alcohols described above and having 2 to 14 carbon atoms. Alkylene oxides suitable for the alkoxylation reaction are, in particular, ethylene oxide and propylene oxide, which in the alkoxylation reaction may be used in any order or else in a mixture.

Suitable polyether polyols are also the polyoxytetramethylene glycols which can be prepared, for example, by polymerization of tetrahydrofuran as described in Angew. Chem. 1960, 72, 927-934.

Preferred hydroxyl group containing compounds are the aforementioned simple polyhydric alcohols, ester alcohols or ether alcohols, of the molecular weight range 62 to 1000 g/mol. Particularly preferred are the diols and/or triols having 2 to 6 carbon atoms, as stated above within the list of the simple polyhydric alcohols. Especially preferred hydroxyl group containing compounds are selected from the group consisting of 1,2-ethylene glycol, di-, tri- and tetraethylene glycol, 1,2- and 1,3-propylene glycol, 1,3-butanediol, 1,4-butanediol, 1,6-hexanediol and 1,1,1-trimethylolpropane or mixtures thereof.

The starting diisocyanates and hydroxyl group containing compounds are preferably reacted in an equivalent ratio of isocyanate groups to hydroxyl groups of 4:1 to 200:1, preferably of 5:1 to 50:1 and more preferably 5:1 to 40:1. Moreover, the presence of at least one suitable catalyst of the type stated is preferred.

It is also preferred to perform the first step of the conversion (formation of urethane containing polyisocyanate) and subsequent reaction towards the inventive aromatic allophanate polyisocyanate in one batch. It is nevertheless possible to separate the urethane containing polyisocyanate, e. g. by evaporation of excess diisocyanate, and convert into the inventive aromatic allophanate polyisocyanate using a different diisocyanate reactant.

Suitable catalysts for preparing the inventive aromatic allophanate polyisocyanates or for being used in the inventive process are, for example, simple tertiary amines, such as, for example, triethylamine, tributylamine, N,N-dimethylaniline, N-ethylpiperidine, N,N′-dimethylpiperazine, or tertiary phosphines, such as triethylphosphine, tributylphosphine or dimethylphenylphosphine, for example. Other suitable catalysts are the tertiary hydroxyalkylamines described in GB 2 221 465, such as triethanolamine, N-methyldiethanolamine, dimethylethanolamine, N-isopropyldiethanolamine and 1-(2-hydroxyethyl)pyrrolidine, for example, or the catalyst systems known from GB 2 222 161, which consist of mixtures of tertiary bicyclic amines, such as DBU, for example, with simple aliphatic alcohols of low molecular weight.

Likewise suitable as catalysts are a multiplicity of different metal compounds. Examples of those suitable are the octoates and naphthenates, as described as catalysts in DE-A 3 240 613, of manganese, iron, cobalt, nickel, copper, zinc, zirconium, cerium or lead, or mixtures thereof with acetates of lithium, sodium, potassium, calcium or barium; the sodium and potassium salts, known from DE-A 3 219 608, of linear or branched alkanecarboxylic acids having up to 10 carbons, such as those of propionic acid, butyric acid, valeric acid, caproic acid, heptanoic acid, caprylic acid, pelargonic acid, capric acid and undecylic acid; the alkali metal or alkaline earth metal salts, known from EP-A 0 100 129, of aliphatic, cycloaliphatic or aromatic mono- and polycarboxylic acids having 2 to 20 carbons, such as sodium benzoate or potassium benzoate, for example; the alkali metal phenoxides known from GB 1 391 066 A and GB 1 386 399 A, such as sodium phenoxide or potassium phenoxide, for example; the alkali metal and alkaline earth metal oxides, hydroxides, carbonates, alkoxides and phenoxides known from GB 809 809, alkali metal salts of enolizable compounds, and also metal salts of weak aliphatic and/or cycloaliphatic carboxylic acids, such as, for example, sodium methoxide, sodium acetate, potassium acetate, sodium acetoacetate, lead 2-ethylhexanoate and lead naphthenate; the basic alkali metal compounds, complexed with crown ethers or polyether alcohols, which are known from EP-A 0 056 158 and EP-A 0 056 159, such as complexed sodium or potassium carboxylates, for example; the pyrrolidinone potassium salt known from EP-A 0 033 581; the monocyclic or polycyclic complex compounds of titanium, zirconium and/or hafnium that are known from EP-A 2 883 895, such as, for example, zirconium tetra-n-butylate, zirconium tetra-2-ethylhexanoate and zirconium tetra-2-ethylhexylate; and also tin compounds of the type described in European Polymer Journal, 16, 1979, 147-148, such as, for example, dibutyltin dichloride, diphenyltin dichloride, triphenylstannanol, tributyltin acetate, tributyltin oxide, tin octoate, dibutyl(dimethoxy)stannane and tributyltin imidazolate.

Other catalysts suitable for preparing the polyisocyanates are, for example, the quaternary ammonium hydroxides known from DE-A 1 667 309, EP-A 0 013 880 and EP-A 0 047 452, such as, for example, tetraethylammonium hydroxide, trimethylbenzylammonium hydroxide, N,N-dimethyl-N-dodecyl-N-(2-hydroxyethyl)ammonium hydroxide, N-(2-hydroxyethyl)-N,N-dimethyl-N-(2,2′-dihydroxymethylbutyl)ammonium hydroxide and 1-(2-hydroxyethyl)-1,4-diazabicyclo[2.2.2] octane hydroxide (monoadduct of ethylene oxide and water on to 1,4-diazabicyclo[2.2.2]octane); the quaternary hydroxyalkylammonium hydroxides known from EP-A 37 65 or EP-A 10 589, such as, for example, N,N,N-trimethyl-N-(2-hydroxyethyl)ammonium hydroxide, the trialkylhydroxyalkylammonium carboxylates known from DE-A 2631733, EP-A 0 671 426, EP-A 1 599 526 and U.S. Pat. No. 4,789,705, such as, for example, N,N,N-trimethyl-N-2-hydroxypropylammonium p-tert-butylbenzoate and N,N,N-trimethyl-N-2-hydroxypropylammonium 2-ethylhexanoate; the quaternary benzylammonium carboxylates known from EP-A 1 229 016, such as, for example, N-benzyl-N,N-dimethyl-N-ethylammonium pivalate, N-benzyl-N,N-dimethyl-N-ethylammonium 2-ethylhexanoate, N-benzyl-N,N,N-tributylammonium 2-ethylhexanoate, N,N-dimethyl-N-ethyl-N-(4-methoxybenzyl)ammonium-2-ethylhexanoate or N,N,N-tributyl-N-(4-methoxybenzyl)ammonium pivalate; the tetra-substituted ammonium α-hydroxycarboxylates known from WO 2005/087828, such as, for example, tetramethylammonium lactate; the quaternary ammonium or phosphonium fluorides known from EP-A 0 339 396, EP-A 0 379 914 and EP-A 0 443 167, such as, for example, N-methyl-N,N,N-trialkylammonium fluorides with C₈-C₁₀ alkyl radicals, N,N,N,N-tetra-n-butylammonium fluoride, N,N,N-trimethyl-N-benzylammonium fluoride, tetramethylphosphonium fluoride, tetraethylphosphonium fluoride or tetra-n-butylphosphonium fluoride; the quaternary ammonium and phosphonium polyfluorides known from EP-A 0 798 299, EP-A 0 896 009 and EP-A 0 962 455, such as, for example, benzyltrimethylammonium hydrogenpolyfluoride; the tetraalkylammonium alkylcarbonates known from EP-A 0 668 271, which are obtainable by reaction of tertiary amines with dialkyl carbonates; or quaternary ammonioalkylcarbonates with betaine structure; the quaternary ammonium hydrogencarbonates known from WO 1999/023128, such as, for example, choline bicarbonate; the quaternary ammonium salts obtainable from tertiary amines and alkylating esters of phosphorus acids, known from EP 0 102 482, such as, for example, reaction products of triethylamine, DABCO or N-methylmorpholine with dimethyl methane phosphonate; or the tetra-substituted ammonium salts of lactams that are known from WO 2013/167404, such as, for example, trioctylammonium caprolactamate or dodecyltrimethylammonium caprolactamate.

These catalysts may be used either individually or in the form of any desired mixtures with one another.

In a further preferred embodiment, the allophanatization catalyst is selected from the group consisting of compounds having one or more metals of the I-, II-, III-, IV- or V-A group (main groups) or of the II-, IV-, VI-, VII- or VIII-B group (sub groups) of the periodic system of elements, preferably is a compound containing lead, zinc, tin, zirconium, bismuth, calcium, magnesium and/or lithium, more preferably a compound containing zinc, zirconium, bismuth and/or lithium and most preferably a compound containing zinc and/or zirconium.

A compound containing tin means a compound containing tin in the molecule like tin halides such as tin dichloride.

A compound containing zinc means a compound containing zinc in the molecule. Zinc halide such as zinc dichloride, zinc carboxylates such as zinc 2-ethylhexanoate, zinc naphthenate and the like are preferable. Zinc 2-ethylhexanoate and zinc naphthenate are more preferable, and among them zinc 2-ethylhexanoate is most preferable.

A compound containing zirconium means a compound containing zirconium in the molecule.

Zirconyl halides, zirconium halides, tetraalkoxyzirconium, zirconium carboxylates, zirconyl carboxylates (carboxyl acid salt of zirconium oxide), and the like are preferable. Particularly zirconium carboxylate and tetraalkoxyzirconium are more preferable, and among them zirconium carboxylate is most preferable.

In a further preferred embodiment, the catalyst is a zinc carboxylate, zinc halide, zirconyl halide, tetraalkoxyzirconium, zirconium carboxylate and/or zirconyl carboxylate, preferably a zinc carboxylate, zirconium carboxylate and/or tetraalkoxyzirconium, more preferably zinc 2-ethylhexanoate, zinc naphthenate and/or zirconium 2-ethylhexanoate.

In the inventive process the amount of catalyst may be selected freely within a broad range. However, for most catalysts, especially for the preferred and further preferred compounds, it is preferred to employ the catalyst in a concentration of 0.0005 to 5.0% by weight, preferably of 0.0010 to 2.0% by weight and more preferably of 0.0015 to 1.0% by weight, based on the amount of the starting diisocyanates used.

The addition of the catalysts to the starting diisocyanates is made preferably in bulk. To improve their compatibility, however, the stated catalysts may optionally also be used in solution in a suitable organic solvent. The degree of dilution of the catalyst solutions in this case may be selected freely within a very broad range. Catalyst solutions typically acquire catalytic activity from a concentration of 0.01% by weight upwards.

Suitable catalyst solvents are, for example, solvents that are inert towards isocyanate groups, such as, for example, hexane, toluene, xylene, chlorobenzene, ethyl acetate, butyl acetate, diethylene glycol dimethyl ether, dipropylene glycol dimethyl ether, ethylene glycol monomethyl ether acetate, ethylene glycol monoethyl ether acetate, diethylene glycol ethyl ether acetate, diethylene glycol butyl ether acetate, propylene glycol monomethyl ether acetate, 1-methoxyprop-2-yl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, and also solvents such as N-methylpyrrolidone and N-methylcaprolactam, 1,2-propylene carbonate, methylene chloride, dimethyl sulfoxide, triethyl phosphate or any desired mixtures of such solvents.

Catalyst solvents could be solvent carring groups that are reactive towards isocyanate groups. Examples of such solvents are mono- or polyhydric simple alcohols, such as methanol, ethanol, n-propanol, isopropanol, n-butanol, n-hexanol, 2-ethyl-1-hexanol, ethylene glycol, propylene glycol, the isomeric butanediols, 2-ethyl-1,3-hexanediol or glycerol; ether alcohols, such as 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid polyethylene glycols, polypropylene glycols, mixed polyethylene/polypropylene glycols and also their monoalkyl ethers, of relatively high molecular weight; ester alcohols, such as ethylene glycol monoacetate, propylene glycol monolaurate, glyceryl mono- and diacetate, glyceryl monobutyrate or 2,2,4-trimethyl-1,3-pentanediol monoisobutyrate; unsaturated alcohols such as allyl alcohol, 1,1-dimethyl allyl alcohol or oleyl alcohol; araliphatic alcohols such as benzyl alcohol; and N-monosubstituted amides, such as N-methylformamide, N-methylacetamide, cyanoacetamide or 2-pyrrolidinone, for example, or any desired mixtures of such solvents.

The urethane groups containing polyisocyanate formed in step (i) of the inventive process are, optionally under inert gas, such as nitrogen, and optionally in the presence of solvent, examples being those as listed above as possible catalysts solvents inert towards isocyanate groups, reacted with an excess of at least one aromatic diisocyanate in the presence of a suitable catalyst as described above, preferably admixed with a suitable catalyst in the quantity stated above at a temperature between 40 and 150° C., preferably between 50 and 130° C., more preferably between 80 and 120° C., where after the reaction to form allophanate structures begins. This conversion can be monitored by titrimetrically measuring the NCO content in % by weight in accordance with DIN EN ISO 11909:2007-05.

After complete conversion, the allophanate formation is discontinued. Discontinuation of reaction may take place, for example, by cooling of the reaction mixture to 20° C.

Preferably, however, the reaction is discontinued by addition of a catalyst stopper and optional subsequent brief heating of the reaction mixture to a temperature, for example, which is above 50° C. Without deactivating the catalyst, there is a likelihood to an undesired high monomer content product and/or high viscous product by further conversion of the allophanate containing polyisocyanate, e. g. by forming isocyanurate groups.

By using a catalyst stopper, the stable, constant value of low monomer of the inventive allophanate polyisocyanate can be further improved.

Examples of suitable catalyst stoppers are inorganic acids such as hydrochloric acid, phosphorous acid or phosphoric acid, acyl chlorides such as acetyl chloride, benzoyl chloride or isophthaloyl dichloride, sulfonic acids and sulfonic esters, such as methanesulfonic acid, p-toluenesulfonic acid, trifluoromethanesulfonic acid, perfluorobutanesulfonic acid, dodecylbenzenesulfonic acid, methyl and ethyl p-toluenesulfonate, mono- and dialkyl phosphates such as monotridecyl phosphate, dibutyl phosphate and dioctyl phosphate, but also silylated acids, such as trimethylsilyl methanesulfonate, trimethylsilyl trifluoromethanesulfonate, tris(trimethylsilyl) phosphate and diethyl trimethylsilyl phosphate.

In a preferred embodiment of the inventive process, the deactivation of the catalyst in step (iii) is conducted by addition of at least one catalyst stopper, wherein the catalyst stopper is selected from the group of sulfonic acid, monoalkyl phosphate, dialkyl phosphate or mixtures thereof, more preferably selected from the group consisting of dodecylbenzenesulfonic acid, p-toluenesulfonic acid, monobutyl phosphate, dibutyl phosphate and dioctyl phosphate or mixtures thereof and most preferably selected from the group consisting of dodecylbenzenesulfonic acid and dibutyl phosphate or mixtures thereof.

Especially preferred are the following catalyst/stopper combinations zinc carboxylates with sulfonic acids and/or zirconium carboxylates with dialkyl phosphates, more preferably zinc octoate with dodecylbenzenesulfonic acid and/or zirconium octoate with dibutyl phosphate.

The amount of catalyst stopper needed in order to discontinue the reaction is governed by the amount of catalyst used; generally speaking, an equivalent amount of the catalyst stopper is used, based on the catalyst used at the start. If, however, in order to fully deactivate the catalyst and achieve a stable product during later treatment (for example physical distillation of excess isocyanate monomers) and/or later storage, excess amount of catalyst stopper is preferred. Preferred amount of catalyst stopper is ≥101 equivalent-%, preferably ≥150 equivalent-% and more preferably ≥200 equivalent-%, based on the molar amount of active metal in the catalyst used. However, depending e.g. on the reaction conditions and starting materials, including the selected catalyst, the catalyst used at start may partially decompose or be partially deactivated during the reaction. Thus, an amount of catalyst stopper of ≥50 equivalent-%, based on the molar amount of active metal in the catalyst used at start, can also be sufficient to discontinue the reaction.

The use of stoppers is linked with the beneficial technical effect that subsequent aromatic allophanate group cleavage is further reduced and the inventive aromatic allophanate polyisocyanate is further stabilized. Thus, another subject of the present invention is the use of a catalyst stopper selected from the group consisting of inorganic acids, acyl chlorides, sulfonic acids, sulfonic esters, mono- and dialkyl phosphates and silylated acids or mixtures thereof for prohibiting aromatic allophanate group cleavage. The use of catalyst stoppers therefore can among other positive influences improve the storage properties of the inventive aromatic allophanate polyisocyanate and the inventive polyisocyanate composition.

Preferably the catalyst stopper in the before mentioned use is selected from the group consisting of hydrochloric acid, phosphorous acid, phosphoric acid, acetyl chloride, benzoyl chloride, isophthaloyl dichloride, methanesulfonic acid, p-toluenesulfonic acid, trifluoromethanesulfonic acid, perfluorobutanesulfonic acid, dodecylbenzenesulfonic acid, methyl and ethyl p-toluenesulfonate, monotridecyl phosphate, monobutyl phosphate, dibutyl phosphate and dioctyl phosphate, trimethylsilyl methanesulfonate, trimethylsilyl trifluoromethanesulfonate, tris(trimethylsilyl) phosphate and diethyl trimethylsilyl phosphate or mixtures thereof, more preferably selected from the group consisting of sulfonic acid, monoalkyl phosphate, dialkyl phosphate or mixtures thereof, even more preferably selected from the group consisting of dodecylbenzenesulfonic acid, p-toluenesulfonic acid, monobutyl phosphate, dibutyl phosphate and dioctyl phosphate and most preferably the catalyst stopper is selected from the group consisting of dodecylbenzenesulfonic acid and dibutyl phosphate.

The stated catalyst stoppers may be used either in bulk or in solution in a suitable solvent. Examples of suitable solvents are the solvents already described above as possible catalyst solvents, or mixtures thereof. The degree of dilution may be selected freely within a very broad range, suitability being possessed, for example, by solutions with a concentration of 1.0 wt % or more.

Besides the stated solvents, it is also possible for the aforementioned starting diisocyanates to serve as solvents for the catalyst stoppers, provided they are sufficiently inert towards isocyanate groups, so that storage-stable solutions can be prepared.

After the end of reaction, the reaction mixture is preferably freed from volatile constituents (such as, for example, from excess starting diisocyanates and any solvents additionally used) by evaporation and/or extraction. Evaporation can be conducted at a pressure of below 5.0 mbar, preferably below 1.0 mbar, more preferably below 0.5 mbar, under extremely gentle conditions, as for example at a temperature of 100 to 200° C., preferably of 120 to 180° C. Preferably, thin film- and/or short path evaporation is used for this step.

It is also possible for the stated volatile constituents to be removed from the polyisocyanate by extraction with suitable solvents that are inert towards isocyanate groups, examples being aliphatic or cycloaliphatic hydrocarbons such as pentane, hexane, heptane, cyclopentane or cyclohexane.

Thus, in a further preferred embodiment, the inventive aromatic allophanate polyiscocyanate is synthesized by a) adding a catalyst and convert urethane to allophanate and b) add a catalyst stopper to deactivate the catalyst and stop the reaction.

The invention further provides aromatic allophanate polyisocyanates, obtained or obtainable according to the inventive process or one or more preferred embodiments of the inventive process.

It is also possible to obtain the inventive aromatic allophanate polyisocyanate by converting an urethane groups containing aromatic polyisocyanate with at least one aromatic diisocyanate in the presence of an allophanatization catalyst and subsequent deactivation of the catalyst followed by removal of the unreacted monomeric diisocyanate down to a content of ≤1.5% by weight, preferably ≤1.0% by weight, more preferably ≤0.8% by weight and most preferably ≤0.7% by weight of monomeric diisocyanates, based on the total weight of the aromatic allophanate polyisocyanate. Again, TDI is the most preferred aromatic diisocyanate.

In a further preferred embodiment, the inventive process comprises a further step (v) addition of at least one solvent, which is inert towards isocyanate groups, to the inventive aromatic allophanate polyisocyanate or addition of the inventive aromatic allophanate polyisocyanate to at least one solvent. Preferably, the solvent is an organic solvent which is inert towards isocyanate groups.

In general, the person skilled in the art can select suitable solvents known in polyurethane chemistry, preferred are organic solvents which are inert towards isocyanate groups, for example toluene, xylene, cyclohexane, butyl acetate, ethyl acetate, ethyl glycol acetate, pentyl acetate, hexyl acetate, methoxypropyl acetate, tetrahydrofuran, dioxane, acetone, N-methylpyrrolidone, methyl ethyl ketone, petroleum spirit, relatively highly substituted aromatics as are commercially available, for example, under the name Solvent Naphtha®, Solvesso®, Shellsol®, Isopar®, Nappar® and Diasol®, homologues of benzene, tetralin, decalin and alkanes having more than 6 carbon atoms, conventional plasticizers such as phthalates, sulphonic esters and phosphoric esters and also mixtures of such solvents.

The addition of solvent is preferably conducted to achieve a non-volatile content of ≥40% by weight, preferably ≥60% by weight, and most preferably ≥70% by weight. This gives the further advantage that the obtained polyisocyanate is easier to be handled with proper viscosity without negatively affecting drying time.

Preferably, the non-volatile content consists essentially of the inventive aromatic allophanate polyisocyanate. The term “essentially” means in this regard that preferably ≥50%, more preferably ≥70%, even more preferably ≥90%, still even more preferably ≥95% and most preferably ≥99.5% based on the total non-volatile content are the inventive aromatic allophanate polyisocyanate.

Therefore, another subject of the present invention is a polyisocyanate composition comprising at least one aromatic allophanate polyisocyanate and at least one solvent which is inert towards isocyanate groups, wherein the polyisocyanate composition has a non-volatile content of ≥40% by weight, preferably ≥60% by weight, and most preferably ≥70% by weight. Preferably the solvent is an organic solvent which is inert towards isocyanate groups. Examples of the suitable solvents and the preferred solvents are described above. This subject gives the further advantage that the obtained polyisocyanate is easier to be handled with proper viscosity without negatively affecting drying time.

Preferably, the non-volatile content consists essentially of the inventive aromatic allophanate polyisocyanate. The term “essentially” means in this regard that preferably ≥50%, more preferably ≥70%, even more preferably ≥90%, still even more preferably ≥95% and most preferably ≥99.5% based on the total non-volatile content are the inventive aromatic allophanate polyisocyanate.

Generally, the residual contents of monomeric diisocyanates present in the inventive aromatic allophanate polyisocyanate can be transferred to the inventive polyisocyanate composition, since it comprises essentially the inventive aromatic allophanate polyisocyanate as described above. It is therefore preferred that in the inventive polyisocyanate composition and/or the diluted aromatic allophanate polyisocyanate obtained or obtainable according to the inventive process, the content of monomeric diisocyanates is ≤1.0% by weight, preferably ≤0.7% by weight and most preferably ≤0.5% by weight, based on the total weight of the polyisocyanate composition. This gives the further advantage that the inventive polyisocyanate composition can be used in an even broader range of applications since occupational hygiene, in particular in manual applications, is still further improved.

Preferably the inventive polyisocyanate composition has a NCO content of from ≥2.0 to ≤23.0% by weight, preferably from ≥4.0 to ≤20.0% by weight and particularly preferably from ≥5.0 to ≤16.0% by weight, based on the total weight of the polyisocyanate composition.

In another preferred embodiment the inventive polyisocyanate composition has a viscosity of ≥50 to ≤20000 mPas, preferably of ≥100 to ≤10000 mPas and most preferably of ≥300 to ≤5000 mPas, measured at 23° C. in accordance with DIN EN ISO 3219:1994-10.

Since also the polyisocyanate composition comprises the inventive aromatic allophanate polyisocyanate and therefore exhibits also the superior properties another subject of the present invention is the use of the inventive aromatic allophanate polyisocyanate and/or the inventive polyisocyanate composition as a crosslinker in an adhesive or a coating composition.

The invention therefore further provides a two-component system comprising an isocyanate component A), containing at least one inventive aromatic allophanate polyisocyanate or at least one inventive polyisocyanate composition, and a NCO-reactive component B) containing at least one compound which is reactive towards isocyanate groups, preferably at least one hydroxyl-containing polyester.

For the inventive two-component system, components A) and B) are used generally in amounts corresponding to an equivalents ratio of isocyanate groups to groups that are reactive towards isocyanate groups of 2:1 to 0.5:1, preferably of 1.5:1 to 0.8:1, more preferably of 1.1:1 to 0.9:1.

Examples of suitable compounds which are reactive towards isocyanate groups are hydroxyl group containing polyethers, polyesters, polyamides, polycarbonates, polyacrylates, polybutadienes and mixed types of the hydroxyl group containing polymers mentioned. Low molecular weight diols and polyols, dimeric and trimeric fatty alcohols and also amino-functional compounds can also be used in the two-component system according to the invention. However, hydroxyl-containing polyesters, alkyd resins and polyacrylates are particularly preferred. Also, it is preferred to add fast drying resins such as nitrocellulose and/or cellulose acetobutyrate. In addition, other auxiliaries and additives such as the customary wetting agents, levelling agents, skin prevention agents, antifoams, bonding agents, solvents, matting agents such as silica, aluminium silicates and high-boiling waxes, viscosity-regulating substances, pigments, dyes, UV absorbers, stabilizers against thermal or oxidative degradation can be used in the coatings or adhesive bonds. This composition can for example be used in the form of clear varnishes, in the form of pigmented paints or as an adhesive.

The coating materials or adhesives obtained can be used for coating or adhesively bonding any substrates such as natural or synthetic fibre materials, preferably wood, plastics, leather, paper, textiles, glass, ceramic, plaster or render, masonry, metals or concrete and particularly preferably paper or leather. They can be applied by conventional application methods such as spraying, painting, flooding, casting, dipping, rolling.

Thus, another subject of the present invention is a process for producing a composite system or a coated substrate, which comprises a step in which an inventive two-component system is applied to at least one substrate and comprises at least one further step in which the two-component system applied to the substrate is cured, optionally under the action of heat.

Another subject of the present invention is a composite system or a coated substrate, obtained or obtainable by the inventive process mentioned in the preceding paragraph.

The inventive and comparative examples which follow are intended to illustrate the invention, but without confining it to these examples.

### EXAMPLES

All percentages are, unless indicated otherwise, by weight.

The determination of the NCO contents was carried out titrimetrically in accordance with DIN EN ISO 11909:2007-05.

The residual monomer contents were determined gas-chromatographically using an internal standard in accordance with DIN EN ISO 10283:2007-11.

The molar contents of allophanate, urethane and isocyanurate groups were determined by ¹³C-NMR spectroscopy using CDCl₃ as solvent in accordance with DIN EN ISO 10283:2007-11.

Allophanate mol-%=Integration of peak @154.0-156.0 ppm/(integration of peaks @154.0-156.0 ppm+integration of peaks @151.7-153.7 ppm+integration of peaks @146.7-148.7 ppm/3).

Urethane mol-%=Integration of peak @151.7-153.7 ppm/(integration of peaks @154.0-156.0 ppm+integration of peaks @151.7-153.7 ppm+integration of peaks @146.7-148.7 ppm/3).

Isocyanurate mol-%=(Integration of peak @146.7-148.7 ppm/3)/(integration of peaks @154.0-156.0 ppm+integration of peaks @151.7-153.7 ppm+integration of peaks @146.7-148.7 ppm/3).

The viscosity of synthesized polyisocyanates was measured at 23° C. by use of viscometer (HAAKE Viscotester VT550) with a standard rotator of MV-DIN in accordance with DIN EN ISO 3219:1994-10.

The distribution of the oligomers was determined by gel permeation chromatography in accordance with DIN 55672-1:2016-03 using polystyrene as standard and tetrahydrofuran as eluent.

The non-volatile content (NVC) was determined in accordance with DIN EN ISO 3251:2008-06 using a drying temperature and time of 2 hours at 120° C. and a test dish diameter of 75 mm and a weighed-in quantity of 2.00 g +/−0.02.

The average isocyanate group functionality F of the allophanate polyisocyanate present in the polyisocyanate composition is determined in accordance with the following formula:

F(GPC)=Mn(GPC)×% NCO(Titr.)/42/% NVC

wherein the NCO content is given in % by weight and is determined titrimetrically in accordance with DIN EN ISO 11909:2007-05, the average number molecular weight (Mn) is determined by gel permeation chromatography (GPC) in accordance with DIN 55672-1:2016-03 using polystyrene as standard and tetrahydrofuran as eluent, and the non-volatile content (NVC) is given in % by weight by testing method in accordance with DIN EN ISO 3251:2008-06 using a drying temperature and time of 2 hours at 120° C. and a test dish diameter of 75 mm and a weighed-in quantity of 2.00 g +/−0.02.

The thinnability of polyisocyanates was evaluated by diluting tested products with ethyl acetate to an applied cup viscosity (16″-18″ by Chinese Tu 4-cup at 23° C.) according to Chinese standard GB/T 1723:1993, and then the non-volatile contents were measured according to the NVC determination method as described above. The drying properties of the coating systems were determined in accordance with DIN 53 150:2002-09.

Chemical substance used in the examples:

Polyether LP 112—propylene glycol based polyether polyol with an OH value of 112 mg/g KOH, Mw 1000, functionality is 2; manufactured by Covestro AG

Desmophen® 3170—high functional polyether polyol with an OH value of 100 mg/g KOH, Mw 3350, functionality is 6; manufactured by Covestro AG

Polyether L 300—bifunctional polyether polyol with an OH value of 190 mg/g KOH, Mw 590; manufactured by Covestro AG

Polyether L 800—bifunctional polyether polyol with an OH value of 515 mg/g KOH, Mw 220; manufactured by Covestro AG

Desmophen® 3600 Z—bifunctional polyether polyol with an OH value of 56 mg/g KOH, Mw 2000; manufactured by Covestro AG

PolyTHF 1000—bifunctional polytetrahydrofuran glycol with an OH value of 116 mg/g KOH, Mw 1000, manufactured by BASF SE

Arcol Polyol 1071—trifunctional polyether polyol with an OH value of 235 mg/g KOH, Mw 716; manufactured by Covestro AG

Desmophen® 1300 X, manufactured by Covestro AG, a fatty acid modified polyester polyol with an OH content of 3.2% by weight, and a non-volatile content of approx. 75%.

Desmodur® L75—urethane adduct, NCO % is 13.3%, viscosity at 23° C. is 1600 mPas, NVC % is 75.0%, manufactured by Covestro AG.

Desmodur® IL 1351 EA—TDI isocyanurate, NCO % is 8.0%, viscosity at 23° C. is 350 mPas, NVC % is 51.0%, manufactured by Covestro AG.

Octa-Soligen® Zinc 23—manufactured by OMG Borchers GmbH.

Octa-Soligen® Zinc 12—manufactured by OMG Borchers GmbH.

Octa-Soligen® Zirconium 18—manufactured by OMG Borchers GmbH.

Borchi® Kat 22—manufactured by OMG Borchers GmbH.

Dodecylbenzenesulfonic acid—NACURE 5076, manufactured by King Industries.

Dibutyl phosphate—supplied by Sigma-Aldrich (Shanghai) Trading Co., Ltd.

### Example 1 (Inventive)

1700 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 95° C., and 125 parts of diethylene glycol were added. After reaching an isocyanate (NCO) content of 39.6%, 0.05 parts of Octa-Soligen® Zinc 23 were added into the reaction mixture to form allophanate, until the NCO content decreased to 36.7%. Then 0.08 parts of dibutylphosphate (DBP) were added to fully stop the reaction. The excess monomeric isocyanate was then removed under reduced pressure. The obtained resin was dissolved in ethyl acetate to get a polyisocyanate composition P1 with the following characteristics:

Isocyanate group content: 14.4%
Non-volatile content: 73.8%
Viscosity: 921 mPas

### Free TDI %: 0.45%

Allophanate %: 61.0 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=4.1

### Example 2 (Comparative)

1700 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 95° C., and 125 parts of diethylene glycol was added. After reaching an isocyanate (NCO) content of 39.6%, 0.018 parts of Octa-Soligen® Zinc 23 were added into the reaction mixture to react till NCO content decreased to 36.4%. The excess monomeric isocyanate was then removed under reduced pressure. The obtained resin was dissolved in ethyl acetate to get a polyisocyanate composition P2 with the following characteristics:

Isocyanate group content: 14.0%
Non-volatile content: 73.1%
Viscosity: 1343 mPas

### Free TDI %: 1.68%

Allophanate %: 61.7 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=4.2

TABLE 1
Storage stability at 50° C., increase of free TDI over time

| Polyisocyanate | | TDI %/ | TDI %/ | TDI %/ |
|---|---|---|---|---|
| composition | Stopper | 0 days | 15 days | 22 days |
| P1 | DBP | 0.45 | 0.53 | 0.53 |
| P2 | no deactivation | 1.68 | 1.89 | 2.39 |

### Example 3 (Comparative)

4000 parts of a mixture of tolylene diisocyanate, containing approx. 80% tolylene 2,4-diisocyanate and approx. 20% tolylene 2,6-diisocyanate, were added to a 41 flask with stirrer equipped with a reflux condenser, dropping funnel and nitrogen inlet. The mixture was heated to 85° C., and 271 parts of diethylene glycol was added. After reaching an isocyanate (NCO) content of 40.13%, 4.12 parts of Octa-Soligen® Zinc 12 (10% solution in 2-ethylhexane-1,3-diol) were added into the reaction mixture and heated up to 95° C. to react until NCO content decreased to 35.8%. Next, 0.12 parts of dodecylbenzenesulfonic acid were added to deactivate the catalyst. The excess monomeric isocyanate was then removed under reduced pressure. The obtained resin was dissolved in ethyl acetate to get a polyisocyanate composition P3 with the following characteristics:

Isocyanate group content: 12.6%
Non-volatile content: 74.5%
Viscosity: 21770 mPas

### Free TDI %: 4.11%

Allophanate %: 76.6 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=4.3

### Example 4 (Inventive)

1000 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 85° C., and 73.5 parts of diethylene glycol was added. After reaching an isocyanate (NCO) content of 39.4%, 0.53 parts of Octa-Soligen® Zinc 12 (10% solution in 2-ethylhexane-1,3-diol) were added into the reaction mixture and heated up to 95° C. to react till NCO content decreased to 37.9%. 0.15 parts of dodecylbenzenesulfonic acid were added to deactivate the catalyst. The excess monomeric isocyanate was then removed under reduced pressure. The obtained resin was dissolved in ethyl acetate to get a polyisocyanate composition P4 with the following characteristics:

Isocyanate group content: 13.9%
Non-volatile content: 74.9%
Viscosity: 450 mPas

### Free TDI %: 0.19%

Allophanate %: 32.2 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=3.0

### Example 5 (Inventive)

1700 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 85° C., and 103.5 parts of diethylene glycol were added. After reaching an isocyanate (NCO) content of 40.6%, 0.0782 parts of Octa-Soligen® Zinc 12 were added into the reaction mixture and heated up to 95° C. to react until NCO content decreased to 36.8%. 0.2 parts of dodecylbenzenesulfonic acid were added to deactivate the catalyst. The excess monomeric isocyanate was then removed under reduced pressure. The obtained resin was dissolved in ethyl acetate to get a polyisocyanate composition P5 with the following characteristics:

Isocyanate group content: 14.4%
Non-volatile content: 73.7%
Viscosity: 1181 mPas

### Free TDI %: 0.32%

Allophanate %: 87.7 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=4.7

### Example 6 (Inventive)

1700 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 85° C., and 125 parts of diethylene glycol were added. After reaching an isocyanate (NCO) content of 39.6%, the reaction temperature was increased to 95° C., and 0.041 parts of Octa-Soligen® Zinc 12 were added into the resulted reaction mixture and reacted till NCO contend decreased to 37.5%. 0.125 parts of dodecylbenzenesulfonic acid were added to deactivate the catalyst. The excess monomeric isocyanate was then removed under reduced pressure. The obtained resin was dissolved in ethyl acetate to get a polyisocyanate composition P6 with the following characteristics:

Isocyanate group content: 14.0%
Non-volatile content: 73.7%
Viscosity: 367 mPas

### Free TDI %: 0.27%

Allophanate %: 39.2 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=3.5

### Example 7 (Inventive)

1600 parts of a mixture of tolylene diisocyanate, containing approx. 80% tolylene 2,4-diisocyanate and approx. 20% tolylene 2,6-diisocyanate, were added to a 2 L flask with stirrer equipped with a reflux condenser, dropping funnel and nitrogen inlet. The mixture was heated to 85° C., and 108 parts of diethylene glycol was added. After reaching an isocyanate (NCO) content of 40.1%, 0.0.31 parts of Octa-Soligen® Zirconium 18 were added into the resulted reaction mixture and heated up to 100° C. to react till NCO content decreased to 35.2%. 0.34 parts of dibutyl phosphate (DBP) were added to deactivate the catalyst. The excess monomeric isocyanate was then removed under reduced pressure. The obtained resin was dissolved in ethyl acetate to get a polyisocyanate composition P7 with the following characteristics:

Isocyanate group content: 14.5%
Non-volatile content: 74.0%
Viscosity: 1483 mPas

### Free TDI %: 0.45%

Allophanate %: 55.9 mol-% (=molar share of allophanate/(allophanate+urethane+isocyanurate groups))
Isocyanurate %: 10.6 mol-% (=molar share of isocyanurate/(allophanate+urethane+isocyanurate groups))

### F(GPC)=3.8

### Example 8 (Inventive)

1700 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 85° C., and a mixture of 120 parts of diethylene glycol and 50 parts of Arcol Polyol 1071 were added. After reaching an isocyanate (NCO) content of 37.8%, 1.82 parts of Borchi® Kat 22 (10% solution in 2-ethylhexane-1,3-diol) were added into the reaction mixture and heated up to 100° C. to react till NCO content decreased to 32.4%. 0.48 parts of dodecylbenzenesulfonic acid were added to deactivate the catalyst. The excess monomeric isocyanate was then removed under reduced pressure. The obtained resin was dissolved in ethyl acetate to get a polyisocyanate composition P8 with the following characteristics:

Isocyanate group content: 12.8%
Non-volatile content: 71.2%
Viscosity: 1966 mPas

### Free TDJ %: 0.38%

Allophanate %: 56.8 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=4.2

### Example 9 (Inventive)

800 parts of a mixture of tolylene diisocyanate, containing approx. 80% tolylene 2,4-diisocyanate and approx. 20% tolylene 2,6-diisocyanate, were added to a 11 flask with stirrer equipped with a reflux condenser, dropping funnel and nitrogen inlet. The mixture was heated to 85° C., and 200 parts of Polyether L800 were added. After reaching an isocyanate (NCO) content of 30.2%, 0.69 parts of Octa-Soligen® Zinc 12 (10% solution in 2-ethylhexane-1,3-diol) were added into the reaction mixture and heated up to 95° C. to react till NCO content decreased to 26.6%. 0.29 parts of dodecylbenzenesulfonic acid were added to deactivate the catalyst. The excess monomeric isocyanate was then removed under reduced pressure. The obtained resin was dissolved in ethyl acetate to get a polyisocyanate composition P9 with the following characteristics:

Isocyanate group content: 11.3%
Non-volatile content: 74.7%
Viscosity: 536 mPas

### Free TDI %: 0.23%

Allophanate %: 47.6 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=3.7

### Example 10 (Inventive)

1411 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture were heated to 85° C., a mixture of 91.5 parts of trimethylolpropane (TMP) and 46.5 parts of diethylene glycol (DEG) were added. After reaching an isocyanate (NCO) content of 35.5%, 0.26 parts of Borchi® Kat 22 (10% solution in 2-ethylhexane-1,3-diol) were added into the reaction mixture and heated up to 98° C. to react till NCO content decreased to 34.5%. 0.17 parts of dodecylbenzenesulfonic acid were added to deactivate the catalyst. The excess monomeric isocyanate was then removed under reduced pressure. The obtained resin was dissolved in ethyl acetate to get a polyisocyanate composition P10 with the following characteristics:

Isocyanate group content: 15.7%
Non-volatile content: 71.9%
Viscosity: 988 mPas

### Free TDI %: 0.32%

Allophanate %: 15.0 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=3.9

### Example 11 (Inventive)

900 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 85° C., and 575 parts of Polyether LP 112 were added. After reaching an isocyanate (NCO) content of 25.8%, the reaction temperature was increased to 95° C., and 1.33 parts of Borchi® Kat 22 (10% solution in 2-ethylhexane-1,3-diol) were added into the reaction mixture and reacted till NCO contend decreased to 22.7%. 0.75 parts of dodecylbenzenesulfonic acid were added to deactivate the catalyst. The excess monomeric isocyanate was then removed under reduced pressure. The obtained resin was dissolved in ethyl acetate to get a polyisocyanate composition P11 with the following characteristics:

Isocyanate group content: 7.2%
Non-volatile content: 76.1%
Viscosity: 223 mPas

### Free TDI %: 0.14%

Allophanate %: 77.0 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=4.9

### Example 12 (Inventive)

820 parts of a mixture of tolylene diisocyanate, containing approx. 80% tolylene 2,4-diisocyanate and approx. 20% tolylene 2,6-diisocyanate, were added to a 11 flask with stirrer equipped with a reflux condenser, dropping funnel and nitrogen inlet. The mixture was heated to 85° C., and 150 parts of Desmophen 3170 were added. After reaching an isocyanate (NCO) content of 39.6%, the reaction temperature was increased to 95° C., and 1.4 parts of Octa-Soligen® Zinc 12 (10% solution in 2-ethylhexane-1,3-diol) were added into the reaction mixture and reacted till NCO content decreased to 38.8%. 0.39 parts of dodecylbenzenesulfonic acid were added to deactivate the catalyst. The excess monomeric isocyanate was then removed under reduced pressure. The obtained resin was dissolved in ethyl acetate to get a polyisocyanate composition P12 with the following characteristics:

Isocyanate group content: 5.8%
Non-volatile content: 66.4%
Viscosity: 225 mPas

### Free TDI %: 0.49%

Allophanate %: 63.7 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=5.9

### Example 13 (Inventive)

560 parts of a mixture of tolylene diisocyanate, containing approx. 80% tolylene 2,4-diisocyanate and approx. 20% tolylene 2,6-diisocyanate, were added to a 1 L flask with stirrer equipped with a reflux condenser, dropping funnel and nitrogen inlet. The mixture was heated to 85° C., and 380 parts of Polyether L 300 was added. After reaching an isocyanate (NCO) content of 22.7%, the reaction temperature was increased to 95° C., and 2.4 parts of Octa-Soligen® Zinc 12 (10% solution in 2-ethylhexane-1,3-diol) were added into the reaction mixture and reacted till NCO content decreased to 18.5%. 0.60 parts of dodecylbenzenesulfonic acid were added to deactivate the catalyst. The excess monomeric isocyanate was then removed under reduced pressure. The obtained resin was dissolved in ethyl acetate to get a polyisocyanate composition P13 with the following characteristics:

Isocyanate group content: 8.2%
Non-volatile content: 73.8%
Viscosity: 228 mPas

### Free TDI %: 0.13%

Allophanate %: 53.7 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=3.6

### Example 14 (Inventive)

599 parts of a mixture of tolylene diisocyanate, containing approx. 80% tolylene 2,4-diisocyanate and approx. 20% tolylene 2,6-diisocyanate, were added to a 21 flask with stirrer equipped with a reflux condenser, dropping funnel and nitrogen inlet. The mixture was heated to 85° C., and 767 parts of Desmophen 3600 Z were added. After reaching an isocyanate (NCO) content of 18.4%, the reaction temperature was increased to 95° C., and 3.31 parts of Borchi® Kat 22 (10% solution in 2-ethylhexane-1,3-diol) were added into the reaction mixture and reacted till NCO content decreased to 16.5%. 1.70 parts of dodecylbenzenesulfonic acid were added to deactivate the catalyst. The excess monomeric isocyanate was then removed under reduced pressure. The obtained resin was dissolved in ethyl acetate to get a polyisocyanate composition P14 with the following characteristics:

Isocyanate group content: 4.3%
Non-volatile content: 74.5%
Viscosity: 135 mPas

### Free TDI %: 0.06%

Allophanate %: 62.5 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=4.2

### Example 15 (Inventive)

600 parts of a mixture of tolylene diisocyanate, containing approx. 80% tolylene 2,4-diisocyanate and approx. 20% tolylene 2,6-diisocyanate, were added to a 11 flask with stirrer equipped with a reflux condenser, dropping funnel and nitrogen inlet. The mixture was heated to 85° C., and 383 parts of PolyTHF 1000 were added. After reaching an isocyanate (NCO) content of 25.7%, the reaction temperature was increased to 98° C., and 2.70 parts of Borchi® Kat 22 (10% solution in 2-ethylhexane-1,3-diol) were added into the reaction mixture and reacted till NCO contend decreased to 21.8%. 1.83 parts of dodecylbenzenesulfonic acid were added to deactivate the catalyst. The excess monomeric isocyanate was then removed under reduced pressure. The obtained resin was dissolved in ethyl acetate to get a polyisocyanate composition P15 with the following characteristics:

Isocyanate group content: 5.5%
Non-volatile content: 74.9%
Viscosity: 1133 mPas

### Free TDJ %: 0.43%

Allophanate %: 58.3 mol-% (=molar share of allophanate/(allophanate+urethane+isocyanurate groups))
Isocyanurate %: 0 mol-% (=molar share of isocyanurate/(allophanate+urethane+isocyanurate groups))

### F(GPC)=6.4

### Thinnability Evaluation:

As the key component of a two-component polyurethane coating or adhesive formulation, the thinnability of a polyisocyanate crosslinker is a very important requirement for low VOC coating development. In order to evaluate the thinnability of the synthesized allophanate polyisocyanates, ethyl acetate was added to dilute the obtained products to a given viscosity (16″-18″, T4-cup at 23° C.) according to ASTM D 1200-2010. Then the non-volatile content was measured according to DIN EN ISO 3251:2008-06. Resulting non-volatile contents (NVC) are summarized in Table 2.

TABLE 2
Thinnability comparison of different polyisocyanate compositions

| | | | | | | | Desmodur ® L75/ |
|---|---|---|---|---|---|---|---|
| | Desmodur ® | | | | | | Desmodur ® IL 1351 |
| Polyisocyanate | L75 | | | | | | (70:30 by weight) |
| composition | (comparative) | P4 | P6 | P7 | P9 | P10 | (comparative) |
| Viscosity after | 16″89 | 16″07 | 17″34 | 16″09 | 17″90 | 17″55 | 17″06 |
| dilution | | | | | | | |
| NVC % | 56 | 60 | 58 | 55 | 60 | 57 | 47 |

It is clearly shown that by introducing allophanate groups into the product the thinnability could be kept or even improved, while compared to that of the market standard Desmodur L75 (Covestro AG).

### Application Testing:

For polyisocyanate compositions P4-P10, Desmodur® L75 and the mixture Desmodur® L75/Desmodur® IL 1351 (70:30 by weight), drying performance was tested by blending with Desmophen® 1300 X (manufactured by Covestro AG, fatty acid modified polyester polyol with OH content of 3.2% by weight and a non-volatile content of approx. 75%) as NCO-reactive component B). The molar ratio of isocyanate groups to hydroxyl groups was 1:1 and the solid content of the final formulation was 40% by weight, after further diluting with butyl acetate. After being mixed together homogenously, the mixture was immediately applied onto transparent glass panels using a film applicator at a thickness of wet film of 120 μm) and was allowed to dry at 23.5° C. and a humidity of 50%. The drying speed was measured according to DIN 53 150:2002-09 and the obtained results were summarized in Table 3.

TABLE 3
Drying speed of different two-component systems

| Polyisocyanate | | | | | | | | | Desmodur ® L75/ |
|---|---|---|---|---|---|---|---|---|---|
| composition | | | | | | | | | Desmodur ® IL 1351 |
| used in two- | Desmodur ® L75 | | | | | | | | (70:30 by weight) |
| component system | (comparative) | P4 | P5 | P6 | P7 | P8 | P9 | P10 | (comparative) |
| Polyisocyanate | 6.0 | 6.0 | 6.0 | 6.0 | 8.0 | 5.0 | 8.0 | 8.0 | 67.1 |
| Desmophen ® | 12.9 | 10.5 | 10.9 | 13.3 | 15.7 | 8.1 | 11.4 | 15.3 | 100 |
| 1300 X | | | | | | | | | |
| Butyl acetate | 16.5 | 14.5 | 14.6 | 16.7 | 21.5 | 11.0 | 17.0 | 20.3 | 85.0 |
| Drying speed | | | | | | | | | |
| T1 (min) | 10 | 13 | 11 | 9 | 13 | 11 | 11 | 12 | 11 |
| T3 (min) | 239 | 183 | 65 | 240 | 58 | 106 | 182 | 150 | 107 |
| T4 (min) | 333 | 227 | 100 | 305 | 130 | 183 | 244 | 269 | 145 |

The experimental results in table 3 show that the use of the inventive allophanate polyisocyanates in two-component systems leads to the surprising effect of a fast drying speed while keeping beneficial thinnability as well as a high solids content.

1: An aromatic allophanate polyisocyanate based on aromatic diisocyanates, containing
a) ≥15 mol-% of allophanate groups, based on the sum of urethane, allophanate and isocyanurate groups,
b) ≤50 mol-% of isocyanurate groups, based on the sum of urethane, allophanate and isocyanurate groups and
c) ≤1.5% by weight of monomeric diisocyanates, based on the total weight of the aromatic allophanate polyisocyanate.

2: The aromatic allophanate polyisocyanate according to claim 1, containing ≥20 mol-% of allophanate groups, based on the sum of urethane, allophanate and isocyanurate groups.

3: The aromatic allophanate polyisocyanate according to claim 1, containing ≤40 mol-% of isocyanurate groups, based on the sum of urethane, allophanate and isocyanurate groups.

4: The aromatic allophanate polyisocyanate according to claim 1, containing ≤1.0% by weight of monomeric diisocyanates, based on the total weight of the aromatic allophanate polyisocyanate.

5: The aromatic allophanate polyisocyanate according to claim 1, wherein the aromatic diisocyanate is selected from the group consisting of toluene 2,4-diisocyanate, toluene 2,6-diisocyanate, and a mixture of toluene 2,4- and 2,6-diisocyanate.

6: The aromatic allophanate polyisocyanate according to claim 1, wherein the aromatic diisocyanate is a mixture of toluene 2,4- and 2,6-diisocyanate in a weight ratio of from 3:2 to 10:0.

7: The aromatic allophanate polyisocyanate according to claim 1, having an isocyanate functionality of ≥2.5 to ≤8.0.

8: A process for preparing an aromatic allophanate polyisocyanate according to claim 1, comprising the steps of
(i) reacting at least one aromatic diisocyanate with at least one hydroxyl group containing compound to form a urethane groups containing polyisocyanate,
(ii) reacting the urethane group containing polyisocyanate with an excess of at least one aromatic diisocyanate in the presence of at least one catalyst to form allophanate groups,
(iii) stopping the reaction by deactivation of the at least one catalyst, and
(iv) removing the unreacted monomeric diisocyanate.

9: The process according to claim 8, wherein the hydroxyl group containing compound has an average molecular weight of ≥62 to ≤5000.

10: The process according to claim 8, wherein the catalyst is a compound containing one or more selected from the group consisting of lead, zinc, tin, zirconium, bismuth, calcium, magnesium and lithium.

11: The process according to claim 8, wherein the catalyst is selected from the group consisting of a zinc carboxylate, a zinc halide, a zirconyl halide, a tetraalkoxyzirconium, zirconium carboxylate and a zirconyl carboxylate.

12: The process according to claim 8, wherein deactivation of the catalyst in step (iii) is conducted by addition of at least one catalyst stopper, wherein the amount of catalyst stopper is ≥50 equivalent-%, based on the molar amount of active metal in the catalyst used.

13: The process according to claim 8, wherein deactivation of the catalyst in step (iii) is conducted by addition of at least one catalyst stopper, wherein the catalyst stopper is selected from the group of consisting of sulfonic acid, monoalkyl phosphate, dialkyl phosphate, and mixtures thereof.

14: In a method for prohibiting aromatic allophanate group cleavage, the improvement comprising including a catalyst stopper selected from the group consisting of inorganic acids, acyl chlorides, sulfonic acids, sulfonic esters, mono- and dialkyl phosphates and silylated acids, and mixtures thereof.

15: A polyisocyanate composition comprising at least one aromatic allophanate polyisocyanate according to claim 1 and at least one solvent which is inert towards isocyanate groups, wherein the polyisocyanate composition has a non-volatile content of ≥40% by weight.

16: The polyisocyanate composition according to claim 15, having a viscosity of ≥50 to ≤20000 mPas, measured at 23° C. in accordance with DIN EN ISO 3219:1994-10.

17: In a process of crosslinking an adhesive or a coating composition, the improvement comprising including an aromatic allophanate polyisocyanate according to claim 1 as a crosslinker.

18: A two-component system comprising an isocyanate component A), containing at least one aromatic allophanate polyisocyanate according to claim 1, and a NCO-reactive component B), containing at least one compound which is reactive towards isocyanate groups.

19: A process for producing a composite system or a coated substrate, the process comprising applying a two-component system according to claim 18 to at least one substrate and at least one further step in which the two-component system is cured, optionally, under the action of heat.

20: The composite system or coated substrate, obtained by the process according to claim 19.
